(19) United States
(12) Patent Application Publication
(10) Pub. No.: US 2016/0189209 A1
(43) Pub. Date: Jun. 30, 2016

(54) SYSTEM AND METHOD FOR PROVIDING A LOCATION-BASED SOCIAL NETWORK

(71) Applicant: TAP.IN2, INC., Los Angeles, CA (US)

(72) Inventors: Michael S. Jacobs, Redondo Beach, CA (US); Shlomi Moshe, Or Yehuda (IL); Jordan L. Syms, Los Angeles, CA (US); Anthony C. Christopoulos, Pasadena, CA (US)

(73) Assignee: TAP.IN2, INC.

(21) Appl. No.: 15/065,748

(22) Filed: Mar. 9, 2016

Related U.S. Application Data
(62) Division of application No. 14/175,710, filed on Feb. 7, 2014.
(60) Provisional application No. 61/762,019, filed on Feb. 7, 2013.

(51) Int. Cl. G06Q 30/02; G06Q 50/00

(52) U.S. Cl. CPC G06Q 30/0252; G06Q 50/01

(57) ABSTRACT

A location based social network and methods of making and using same. A method according to one embodiment includes configuring an event profile via an event administrator device, where the event profile is associated with an event location and includes at least one location venue. The method also includes configuring an event venue profile via a first venue device, where the event venue profile is associated with a location venue and is configurable via the event administrator device. The method further includes presenting an event interface at an attendee device, where the event interface is defined by the event profile and the event venue profile.

### CROSS-REFERENCE TO RELATED APPLICATIONS

This application is a divisional application of co-pending application Ser. No. 14/175,710, filed on Feb. 7, 2014, which claims the benefit of U.S. Provisional Application Ser. No. 61/762,019, filed Feb. 7, 2013. Priority to each of the prior applications is expressly claimed, and the disclosures of the applications are hereby incorporated herein by reference in their entireties.

### FIELD

The present disclosure relates generally to social networks and more particularly, but not exclusively, to systems and methods for providing a venue-based social network.

### BACKGROUND

Hosts and promoters of events have an increasing need to engage event attendees with social media to increase spending by attendees, to improve customer service, and to improve the experience at events. Unfortunately, it is prohibitively expensive for most hosts and promoters to create and maintain a robust social networking platform for their events.

Although social networks like Facebook, Twitter, and the like provide some social networking functionalities that are relevant to events, these simple social networking tools are unable to provide interfaces that provide for location-based sales and advertising functionalities that are customized for specific events and locations. Moreover, such social networks do not provide event promoters and hosts with the ability to build a social networking platform that can be further customized by vendors, performers and others that may be operating within a given event.

### BRIEF DESCRIPTION OF THE DRAWINGS

FIG. 1 is an exemplary top-level drawing illustrating an embodiment of a social networking system.

FIG. 2 is an exemplary top-level drawing illustrating an embodiment of an event location with a plurality of location-venues suitable for use with the social networking system of FIG. 1.

FIG. 3 is an exemplary detail drawing illustrating an embodiment of an attendee device that is suitable for use with the social networking system of FIG. 1, wherein the attendee device supports an event portal application.

FIG. 4 is an exemplary data flow diagram illustrating an embodiment of a data flow path between a system server and the attendee device of FIG. 3, wherein the data flow sets an attendee position at the event location of FIG. 2.

FIG. 5 is an exemplary data flow diagram illustrating an embodiment of a data flow path between a venue device, the attendee device of FIG. 3 and the system server of FIG. 4, wherein the data flow initiates and processes an order at the event location.

FIG. 6 is an exemplary data flow diagram illustrating an embodiment of a data flow path between an event administrator device, the system server of FIG. 4 and the venue device of FIG. 5, wherein the data flow creates an event profile and event portal.

FIGS. 7A-D are exemplary detail drawings illustrating respective embodiments of user interfaces for creating the event profile and interacting with one or more event profiles in accordance with the event administrator device of FIG. 6.

FIGS. 8A-E are exemplary detail drawings illustrating respective embodiments of user interfaces for interacting with one or more event profiles.

FIG. 9 is an exemplary top-level drawing illustrating an embodiment of a stadium event location for use with the social networking system of FIG. 1.

FIG. 10 is an exemplary data flow diagram illustrating an embodiment of a data flow path between the attendee device and system server, wherein the data flow selects advertisements based on at least one of user location, time in relation to an event-duration, and an attendance indication.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

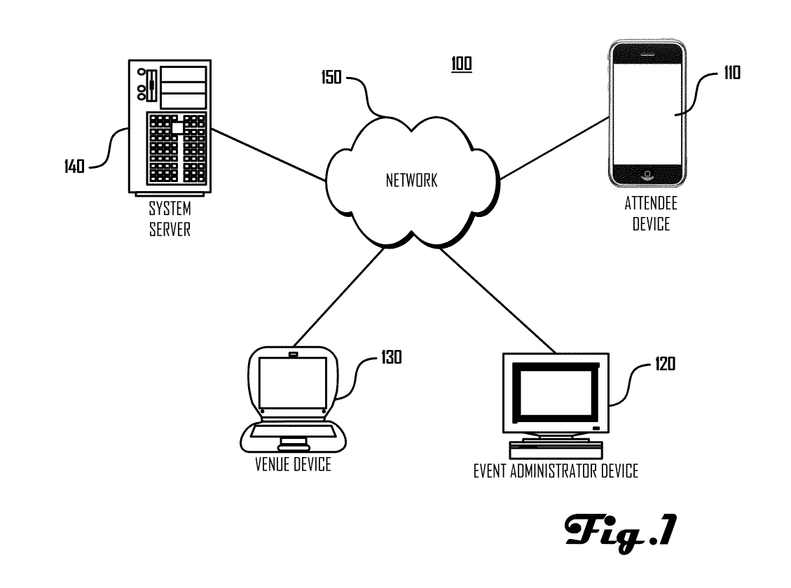

Since currently-available social networking systems fail to effectively provide the ability to plan and execute events based on locations, a social media networking system that provides for location-based social networking can prove desirable and provide a basis for a wide range of social networking applications, such as social networking at a convention, casino, sporting event, night-club, office, performance art event, restaurant, or the like. This result can be achieved, according to one embodiment disclosed herein, by a social media networking system 100 as illustrated in FIG. 1.

Turning to FIG. 1, the social media networking system 100 is shown as including an attendee device 110, an event administrator device 120, a venue device 130, and a system server 140 that are operably connected via a network 150. The attendee device 110 can be a smart-phone; however, in various embodiments, the attendee device 110 can be various suitable devices including a tablet computer, laptop computer, desktop computer, gaming device, or the like without limitation. While the venue device 130 and event administrator device 120 are shown in FIG. 1 as being a laptop computer and desktop computer, respectively, (for purposes of illustration only), these devices 120, 130 can comprise any suitable conventional device in various embodiments.

In various embodiments a venue device 120 can comprise an iBeacon device (Apple, Inc., Cupertino, Calif.), or the like. For example, US Patent Publication 2014/0019367 A1 by Kahn et al., filed on Sep. 28, 2012 (this publication is hereby incorporated herein in its entirety), teaches an iBeacon commercial transaction system and method that can comprise a portion of the system 100 described herein. The described iBeacon device can be used to provide for sales transactions or social networking functionalities as described herein.

Additionally, the system server 140 can be any suitable device or can comprise a plurality of devices or can be a cloud-based data storage system. In various embodiments, the network 150 can comprise one or more suitable wireless or wired network, including the Internet, a local-area network (LAN), a wide-area network (WAN), or the like. Communication between devices on a network 150 can be bi-directional.

In various embodiments, the social media networking system 100 can include a plurality of any of the attendee device 110, event administrator device 120, venue device 130, and/or system server 140. For example, there can be a plurality of attendee users who each have a respective attendee device 110. Additionally, and/or alternatively, a selected device 110, 120, 130, 140 can be configured to perform the function of one or more other devices 110, 120, 130, 140. For example, via a separate administrator and attendee interface discussed in further detail herein accessed on the same device, a venue device 130 can also be used as an attendee device 110. In one embodiment, one or more of the attendee device 110, event administrator device 120, venue device 130, and system server 140 can be absent from the system 100.

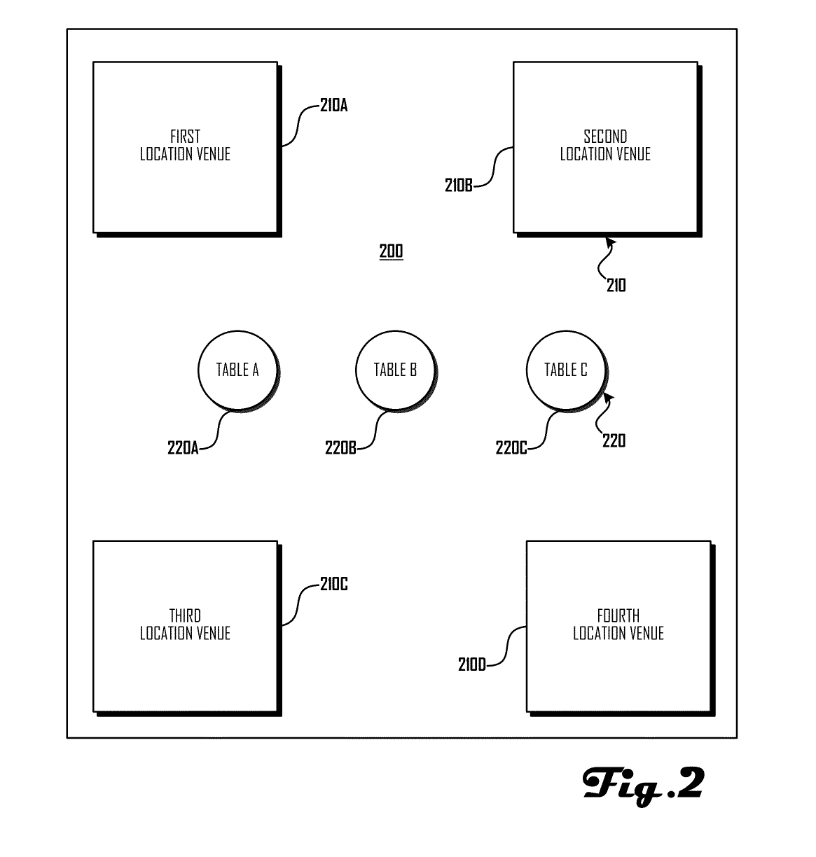

The social media networking system 100 advantageously can be configured to provide location-based social networking at a predetermined location, event, television broadcast, or the like, as discussed in further detail herein. An exemplary location 200 is illustrated in FIG. 2. Referring to FIG. 2, the location 200 can include one or more venues 210 each located at a respective position at or within the location 200. Additionally, or alternatively, the location 200 can include at least one site 220.

For example, the location 200 can be a convention center that is hosting a comic book convention. The convention location 200 can include a comic book booth (e.g., first venue 210A); a convention registration and help desk (e.g., second venue 210B); a performance stage (e.g., third venue 210C); and a concessions vendor (e.g., fourth venue 210D). Additionally, and/or alternatively, the convention location 200 can include one or more other types of amenities such as tables (e.g., sites 220A-220C) where convention attendees can sit and watch activities on the performance stage 210C or eat and drink food from the concessions vendor 210D.

The comic book convention organizer can be associated with an event administrator device 120; the convention venues 210 can be associated with one or more venue device 130; and convention attendees can each be associated with respective attendee devices 110. In an embodiment, two users can share a single device, and/or a given user can be associated with more than one device. As discussed herein, there can be various types of users of the system 100. For example, there can be one or more event administrator user associated with an event administrator device 120; one or more venue user associated with a venue device 130, one or more attendee user associated with an attendee device 110, and one or more system user associated with a system server 140.

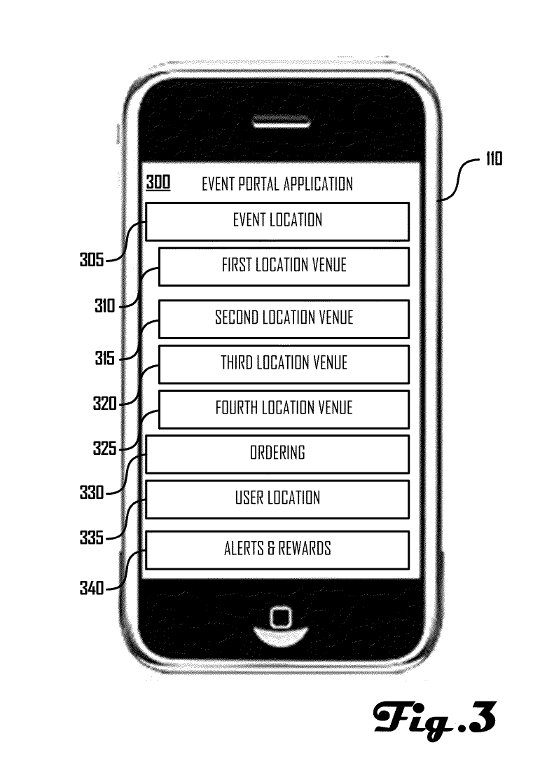

FIG. 3 illustrates an embodiment of the attendee device 110 that is suitable for use with the social media networking system 100. Turning to FIG. 3, a plurality of attendee devices 110 can access a portal or user interface 300, which allows attendees and venues to socially network and interact before, during, and/or after an event. In other words, the attendees can utilize their attendee devices 110 to interact with the venue devices 130 via the portal or user interface 300 at any time. An event organizer can use the event administrator device 120 to administer, edit, and/or modify the portal or user interface 300, and the location-venues can administer, edit and/or modify a portion of the portal or user interface 300 via the location-venue device 130. In some embodiments, one or more attendees also can use the attendee devices 110 to administer, edit, and/or modify the portal or user interface 300.

Returning to the comic book convention example above, the convention organizer can administer an event portal 300 that includes postings related to location-venues 210 (shown in FIG. 2) of the comic book convention. The portal 300 can be accessed and used by event attendees via attendee devices 110. The portal 300 can include a stage venue interface 320 for listing events at the stage venue 210C (shown in FIG. 2). This stage venue interface 320 can be administered via a selected device 120 and/or 130. For example, as the acts, performances, presentations, or other exhibitions at the stage venue 210C change, or as the timing of such exhibitions changes, these changes can be reflected in the stage venue listing 320 on the comic book convention event portal 300.

Additionally, the convention registration and help desk venue 210B (shown in FIG. 2) can also have a portal 315 that allows attendees to perform administrative functions such as check-in, purchase tickets for events, or the like. The convention registration portal 315 can be administered by the venue device 130 (shown in FIG. 1) and/or an event administrator device 120 (shown in FIG. 1) because the convention registration and help desk venue 210B can be associated with the event coordinator. In various embodiments, an event or location-venue 210 (shown in FIG. 2) can be associated with the event administrator or coordinator. Continuing the comic book convention example above, an event administrator can use an event administrator device 120 to setup the event portal 300 but can also use a venue device 130 to modify a portal (e.g., portal 315B) related to the convention registration and help desk, which is associated with the event administrator.

For example, referring again to FIGS. 2 and 3 and the comic book convention example, the concessions vendor location-venue 210D and comic book booth location-venue 201A can be operated independently of the event coordinator or administrator. The concessions vendor venue 210D and comic book booth venue 210A can have respective portals 310, 325 on the event portal 300, which allow attendees to interact with, and socially network with, these venues 210A, 210D via the event portal 300. The portals 310, 325 can be administered by venue devices 130 associated with the vendor venue 210D and comic book booth venue 210A respectively. However, in an embodiment, an event administrator can also be able to make changes to the portals 310, 325 or can modify how the venue administrators can themselves modify the portals 310, 325.

For example, if the administrator of the comic book venue location 210 posts content on its portal 310 that was in violation of the terms of service of the comic book event portal 300, the convention administrator could take action for remedying the violation. Illustrative actions can include removing the violating content, removing the comic book location-venue portal 310, changing the editing permissions of the comic book location-venue portal 310, or the like.

Additionally, the concessions vendor and comic book booth may desire to have various functionalities or displays associated with their respective portals 310, 325. For example, the comic book seller may want its portal 310 to display information about its company, display a list of comic books or other items for sale, display alerts, or allow attendees (or other users) to purchase items through the portal 310, or the like. In various embodiments, the comic book seller can modify the appearance and functionality subject to portal parameters defined by the event administrator (e.g., defined via an administrator device 120).

Similarly, the concession vendor may desire to have various functionalities or displays on its portal 325. In some embodiments, the concession vendor can enable ordering and/or delivery via the associated portal 325. In some embodiments, ordering and delivery can be based on location of an ordering attendee device 110. An attendee user can indicate his location at the event location 200 in various ways. For example, an event location interface 305 in the event portal application can include a map (not shown) of the event location 200 or list of event location positions (not shown) in the event location 200, and the attendee user can be able to indicate his position via the map or list. In one embodiment, a user location interface 335 can allow an attendee user to indicate his position, or the event portal application 300 can prompt an attendee user to confirm or indicate his position. The attendee user can initiate and generate an order of goods or services via an ordering interface 330 on the event portal application 300. As discussed in more detail herein, the order can be generated based on a reported attendee position or position of an attendee device 110. Position detection can occur via one or more conventional methods including sensing global positioning (“GPS”) data, compass data, cell tower proximity data, wireless network proximity data, or the like.

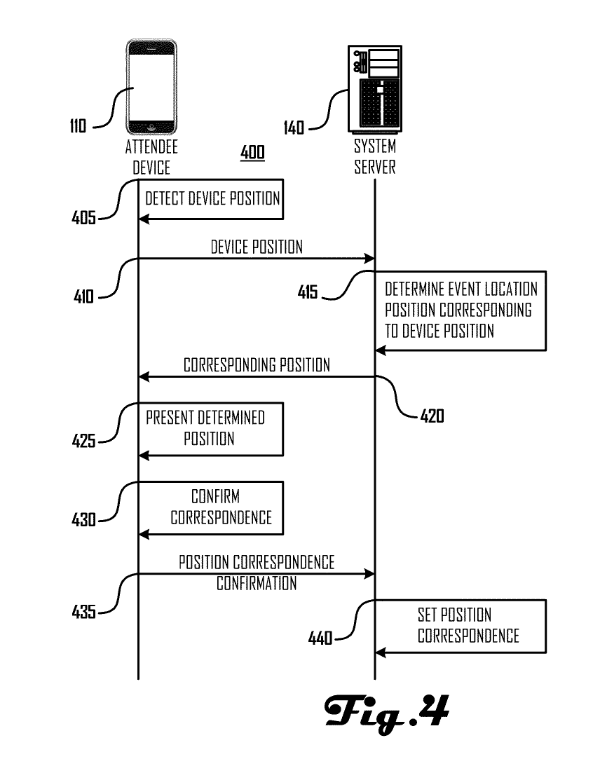

FIG. 4 illustrates an example of a data flow 400 between a selected attendee device 110 and the system server 140 for setting attendee position in an event location 200. Turning to FIG. 4, the data flow 400 begins, at 405, where the attendee device 110 detects a device position. Position detection can occur via one or more conventional methods including sensing global positioning (“GPS”) data, compass data, cell tower proximity data, wireless network proximity data, or the like.

The attendee device 110, at 410, sends a detected device position to the system server 140, where an event location position corresponding to the reported device position is determined, at 415. For example, a selected attendee user can be present at an event location 200 (shown in FIG. 2) and may sit at Table B 220B (shown in FIG. 2). The attendee device 110 of the selected attendee user can detect and report a device position to the system server 140, and an event location position can be determined that corresponds to the reported device position. In this example, the system server 140 can determine that the reported location corresponds to Table B 220B.

The determined corresponding position is sent, at 420, to the attendee device 110 and presented, at 425. The attendee user can then confirm position correspondence, at 430. A confirmation of the attendee user's position correspondence can be sent to the system server 140, at 435, where attendee position correspondence is set, at 440. For example, an attendee user can receive an alert via an event portal application 300 (shown in FIG. 3) to confirm his location within the event location 200 (shown in FIG. 2). The event portal application 300 can present one or more proposed event location positions (e.g., at Table B 220B). In an embodiment, the attendee user can confirm his position, decline to report his position, reject the proposed event location position, select one of a plurality of proposed event location positions or select an event location position that was not proposed.

The event location positions can be an event location site (e.g., tables 220 shown in FIG. 2) or an event location-venue (e.g., event location-venues 210 shown in FIG. 2). In an embodiment, event location sites 220 can include passive or general positions within the event location 200 such as seating areas, gathering areas, bathrooms, or the like, where specific events, sales, presentations, and/or services do not occur. A location-venue 210 can be an active location such as a bar, stage, concessions stand, gaming table, retail station, information booth, or the like.

In some embodiments, passive positions, such as seating areas, can be associated with a location-venue 210. For example, a stage location-venue 210 can have stage seating, a blackjack table can have a plurality of player chairs, a restaurant can have dedicated serving seats, a dance club can have a line, or the like.

In various embodiments, event location positions can be hierarchical. For example, an airport restaurant can have seating and serving areas that are separate from airport common-areas or other vendor dedicated areas. The airport restaurant can also have seating in both a lounge area and a dining area. The lounge area can have seating at a bar or in a general lounge seating area; whereas, the bar can have a plurality of seats. In such an example, a specific position can be a fifth seat, at the bar, in the lounge, and/or at the airport restaurant venue. In an embodiment, a selected attendee can select or report her current position with any desired level of specificity within the position hierarchy. Attendee event location position can be used when the selected attendee orders goods and/or services during the event.

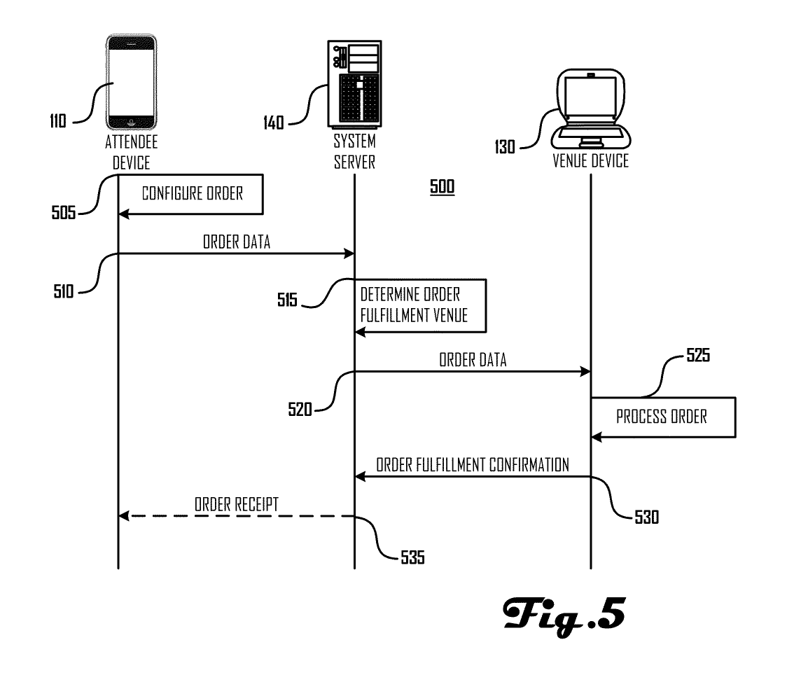

FIG. 5 illustrates an example of a data flow 500 between an attendee device 110, the system server 140, and the venue device 130 for initiating and processing an order at an event location 200. The data flow 500 begins, at 505, where the attendee device 110 configures an order. The attendee device 110 sends the order to the system server 140, at 510. For example, an attendee can use an ordering portal 330 in an event portal application 300 (shown in FIG. 3) to configure the order for goods and/or services at the event location 200 (shown in FIG. 2).

The system server 140 determines an order fulfillment venue, at 515, and sends the order to a venue device 130 associated with the determined order fulfillment venue, at 520. The order is processed by the venue device 130, at 525. For example, and referring to FIG. 2, an event location 200 can be a music concert arena, which includes three concession stand venues 210 (e.g., the first, second and third location-venues 210A, 210B and 210C) and a stage venue 210 (e.g., the fourth location-venue 210D). An order from the attendee device 110 of a selected attendee can include an indication that the selected attendee is sitting at Table C 220C and/or an order request for a beer and a pretzel. Determining an order fulfillment venue can be based on one or more criteria, which can include proximity to a reported attendee position, availability of requested items at a given venue, order fulfillment delay, random selection, round-robin selection, venue fulfillment area designation, or the like.

In the same example, because the user is sitting at Table C 220C, the second concession stand (i.e., the second location-venue 210B) can be selected because the second concession stand is closer to Table C 220C. Alternatively, and/or additionally, despite being far from Table C 220C, the third concession stand (i.e., third location-venue 210C) can be selected because Table C 220C is within a defined service area including Table C 220C; because the first concession stand 210A will provide the fastest service, or the like. In some embodiments, an attendee order can influence order fulfillment venue selection by indicating a specific fulfillment venue; by indicating priority based on location; and/or by indicating priority based on fulfillment time. In some embodiments, a plurality of fulfillment venues can be selected, such as when all items of an order request are not able to be fulfilled by a single location-venue.

Returning to the data flow 500 in FIG. 5, after an order is processed, at 525, an order fulfillment confirmation can be sent to the system server 140, at 530, and optionally, an order receipt is sent to the attendee device 110, at 535. For example, the venue device 130 can process the order, at 525, and present the order to workers at the location-venue 210 associated with the venue device 130. The workers can fulfill the order by preparing requested goods and/or services. In some embodiments, the ordering attendee can visit the location-venue 210 to receive ordered goods or services; however, in some embodiments, goods and/or services can be delivered to a selected event location position such as a table or seat. For example, a worker can deliver drinks ordered from a vendor to the seat of the ordering attendee.

In an embodiment, the venue device 130 can be a smart-phone, or the like, that a worker or other attendant at the location-venue 210 (shown in FIG. 2) can use to receive, process and fulfill orders. For example, a location venue 210 can be a bar that employs a plurality of waiters. Each waiter can have a respective venue device 130 and periodically receive orders from various attendee devices 110. A selected waiter can receive an order from an ordering attendee. The order includes an indication of desired goods (e.g., a martini cocktail), a predetermined attendee identifier, and a predetermined attendee location. The waiter can prepare the desired martini cocktail and take it to the predetermined attendee at the predetermined location. In one embodiment, the venue device 130 can present an image of the desired goods and/or a picture of the ordering attendee to facilitate fulfillment of the order.

In some embodiments, the ordering attendee can pay for her martini cocktail via her attendee device 110 and/or via the venue device 130 carried by the waiter. For example, payment can occur via communication between the attendee device 110 and the venue device (e.g., via RFID, Bluetooth, a “bump”, or the like). Stated somewhat differently, the venue device 130 can support delivery confirmation for attendee orders. The attendee device 110 and/or the venue device 130 can provide for payment in any conventional manner such as via credit card, digital wallet, or other account.

In accordance with various embodiments, dynamic social networking interfaces can be generated by various classes of event organizers, event locations 200 (shown in FIG. 2), and/or event location-venues 210 (shown in FIG. 2). Some embodiments can include an event portal application 300 as illustrated in FIG. 3; however, the interfaces and/or portals can include a webpage, application on a smart-phone or gaming device, and/or an interface/portals present on a device or kiosk at an event location 200 and/or event location-venue 210.

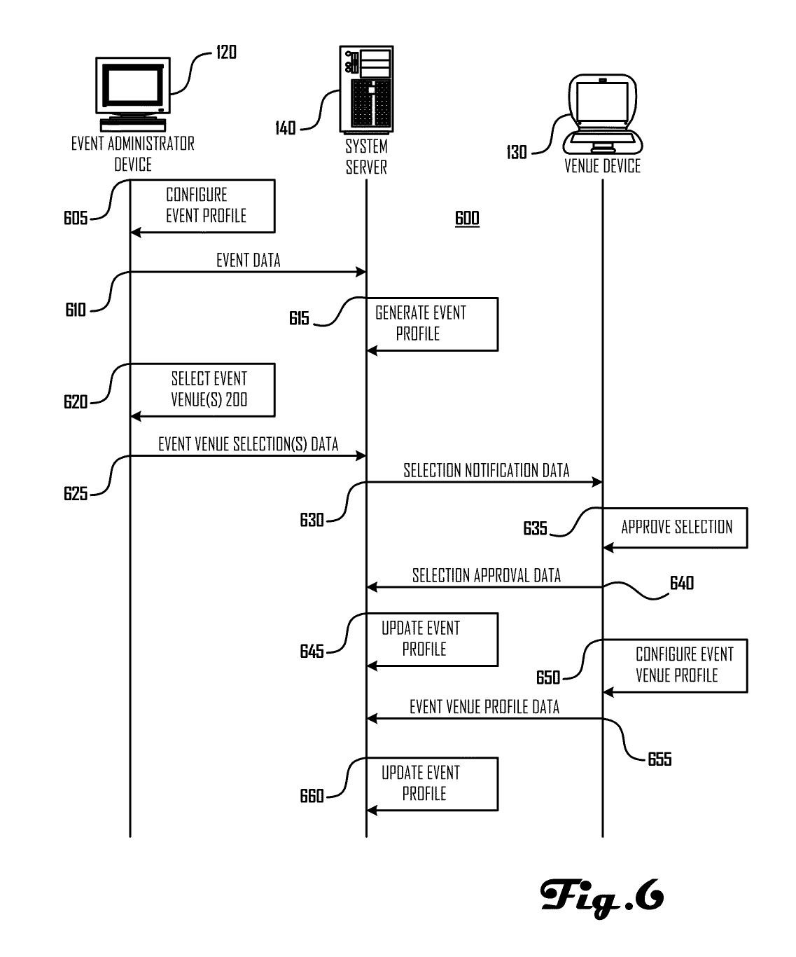

FIG. 6 depicts an example of a data flow 600 between the event administrator device 120, the system server 140, and the venue device 130 for creating an event profile and event portal. The data flow 600 begins, at 605, where the event administrator device 120 configures an event profile and, at 610, sends event profile data to the system server 140. An event profile is generated by the system server 140, at 615.

In an embodiment, an attendee user or event administrator user can organize an event at a location 200 (shown in FIG. 2) and can include location-venues 210 (shown in FIG. 2). Additionally, and/or alternatively, an owner of the location 200 can organize an event at the location 200 and include location-venues 210.

For example, the owner (a location owner) of a pub (an event location 200) can organize a standing event, which is defined by the operating hours of the pub. The pub can include location-venues within the event location (the pub), which can include various amenities that the pub provides such as a bar, a kitchen, a stage, a retail store and the like. Some location-venues 210 at the bar can be static such as the bar, kitchen and retail store; whereas, other location-venues 210, like the stage, at the bar can be dynamic. For example, the stage can include one or more sub-location-venues and/or be replaced by location-venues 210 such as performers or events, which can change nightly or throughout a given night.

The pub's standing event profile can be accessible to attendee users via an event portal application 300 or the like, in the manner set forth above with reference to FIG. 3. As will be discussed further herein, the location-venues 210 and/or sub-location-venues that are not directly associated with the pub can be able to add content to the pub's event profile and event portal. For example, a band that is playing at the pub can be able to link, add information to, or add a further interface or portal to the pub's event profile and event portal. The pub owner (event organizer) can be able to limit how these outside location-venues modify or add to the pub's event profile and event portal.

In another example, an attendee organizer can organize a separate birthday party event at the pub, and the attendee can populate the event location 200 with location-venues 210. Location-venues 210 at the pub can be pre-populated based on the pub's existing event location profile (e.g., the bar, stage, kitchen). However, the organizer can add additional location-venues or location sites to the event profile (e.g., an area reserved for the party, a caterer that is separate from the pub's kitchen or bar, entertainment that is separate from the pub's entertainment or the like).

The data flow 600 continues where the event administrator device 120 selects one or more venues, at 620, and sends event venue selection data to the systems server 140, at 625. Selection notification data is sent to a venue device 130 corresponding to the selected venue 200, at 630, where the venue selection is approved by the venue device 130, at 635, and selection approval data is sent to the system server 140, at 640, where the event profile is updated, at 645. At the venue device 130, an event venue profile is configured, at 650, and data associated with the event venue profile is sent, at 655, to the system server 140, where the event profile is updated, at 660.

Referring to the pub event location example above, the pub (event organizer) can book a band to play on its stage, and the band can be able to add selected content to the event profile and event portal. For example, the band can create a location-venue profile and portal that includes information about the band, upcoming shows, sample music or the ability to purchase band merchandise such as recordings or t-shirts. The band can then be able to incorporate its location-venue profile and event portal in event profiles and event portals for locations and events where the band is playing from night to night.

In an embodiment, attendee users can receive alerts and/or rewards related to an event, event location 200 (shown in FIG. 2), a location venue 210 (shown in FIG. 2) or the like. For example, an attendee user can receive or view alerts and rewards via an alerts and rewards portal 340 of an event portal application 300. In an embodiment, rewards can include discounts on goods and/or services, points or credits toward future purchases of goods and/or services, free goods and/or services, or the like. Alerts can include an opening time, a closing time, specials on goods and/or services, availability of goods and/or services, status of an order, information about an event schedule, or the like.

In an embodiment, rewards can be selectively provided to users based on various criteria. Exemplary criteria can include length of time present at (or absent from) a location venue 210, location site 220, and/or event location 200; user order history; or user presence at a location venue 210, location site 220, and/or event location 200 at a defined time, or the like. For example, when a selected user has been waiting for an extended period of time at a location venue 210 (e.g., at a night-club or restaurant), the social networking system 100 (shown in FIG. 1) an reward the user with discounted goods and/or services to be redeemed when inside the location venue 210. In another example, where a user has not been to an event location 200 for an extended period of time, or when the user breaks a pattern of attendance (e.g., going to a casino every Tuesday night), the user can receive a reward to provide incentive for the user to return to the event location 200.

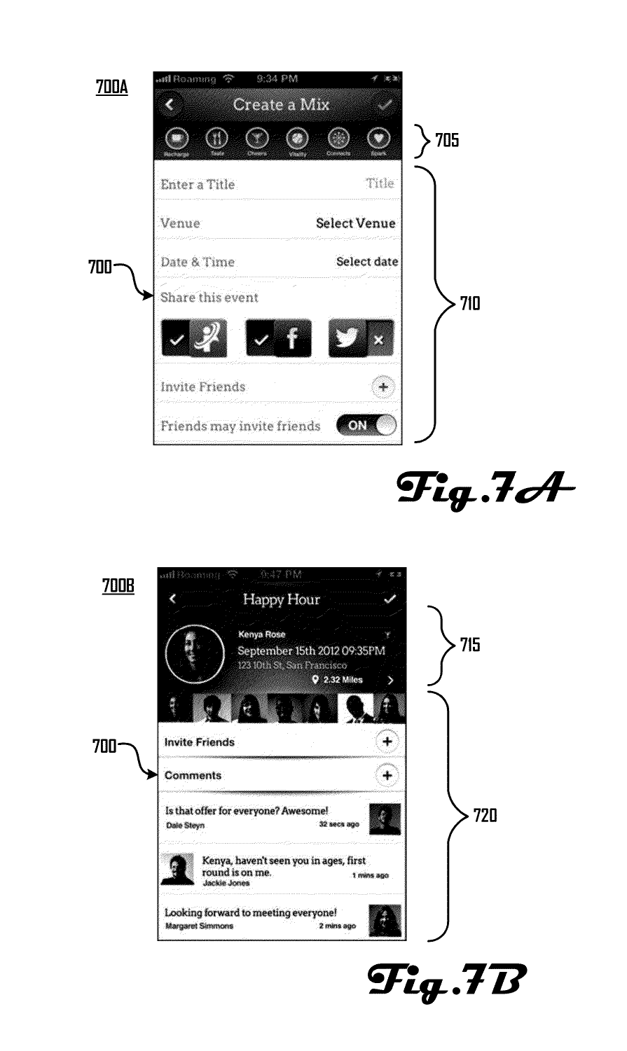

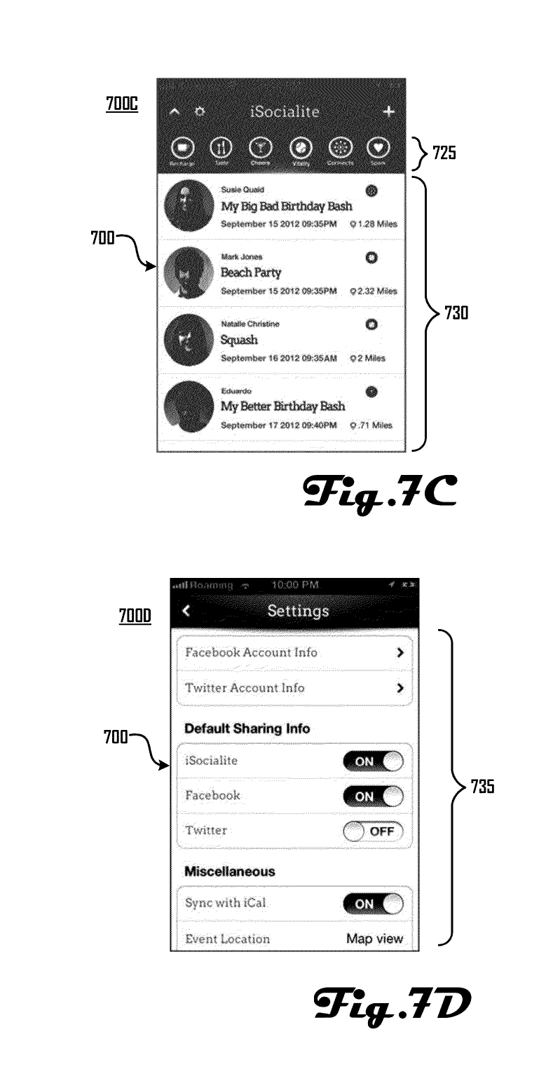

FIGS. 7A-7D are example drawings of a user interface 700 for creating a selected event profile and/or interacting with one or more event profiles. One embodiment is a smart-phone social networking application that allows attendee users and/or event administrator users to organize events with others in one or more social network.

One exemplary embodiment of the user interface 700 is first interface 700A, which is shown in FIG. 7A. Turning to FIG. 7A, the first interface 700A allows a user to create an event The event can be categorized via category bar 705. Information about the event, invitees, sharing preferences, event location (called “venue” in this embodiment), event time and date, and inviting preferences can be input in an event input portion 710. The user can select one or more social network through which the event is shared, which can include, Facebook, Twitter, or the like. Invitation preferences including a setting that allows or disallows invited friends to invite others may be selected as shown.

Second interface 700B is another exemplary user interface 700 and is shown in FIG. 7B. The second interface 700B presents event profile data including event location, event time, and an event organizer profile picture in an event profile header 715. Such an interface can be viewable by the event organizer and by other users, and access to the interface can be controlled by the event organizer. For example, the event organizer can only allow “friends” in one or more social network to view and/or edit event profile data associated with an event that the event organizer creates. In an event networking portion 720, there can be pictures of invitees and portions that allow a user to invite others to an event or to write comments about an event.

Another user interface 700 is third interface 700C, which is shown in FIG. 7C. The third interface 700C allows a user to view a plurality of events. The events can be filtered by event type via a filter bar 725 and/or can be displayed in an event display portion 730. In an embodiment, event coordinators and attendees can have access to the interface 700C. Each displayed event can comprise a profile picture of the user that organized the event, the name of the user that organized the event, the time and date of the event, and a distance to the event location.

Additionally, and/or alternatively, the user interface 700A can include a fourth interface 700D. Turning to FIG. 7D, the fourth interface 700D allows a user to change settings via a settings portion 735, including links to social networks such as Facebook, Twitter, LinkedIn, or the like and sharing of event profile data and user profile data via social networks. For example, FIG. 7D depicts sharing default set such that iSocialite and Facebook social networks are set for sharing by default and the Twitter social network is set for not sharing by default.

In an embodiment, a user can share pictures, video, or audio media via one or more social network, including a social network present within a system 100 (shown in FIG. 1) described herein. For example, an event attendee can take a picture with an attendee device 110 and post it on an event networking portion 720 of the user interface 700. Such a picture can be shared via other social media networks selectively or by default.

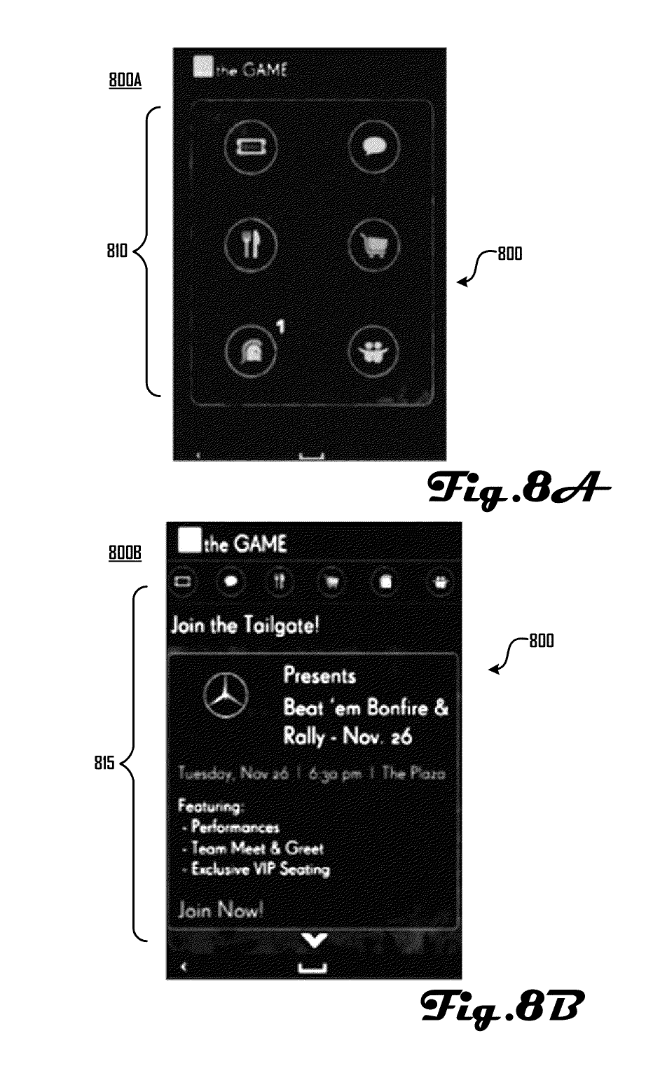

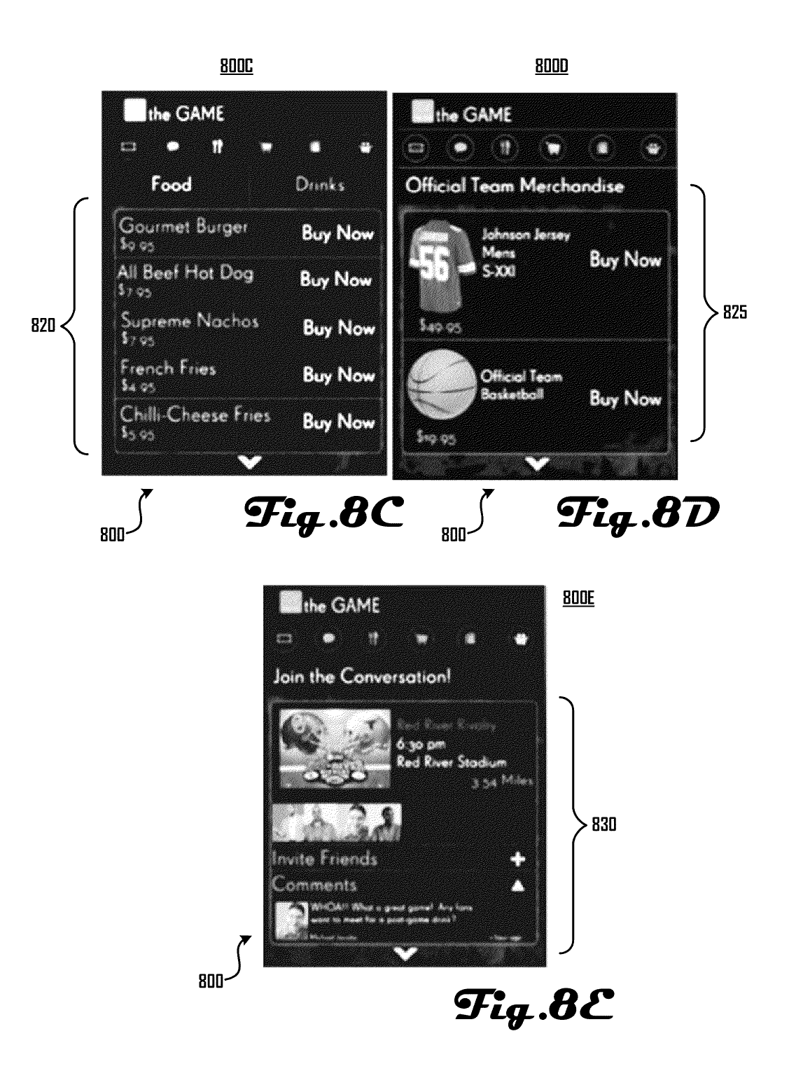

FIGS. 8A-E are example drawings of a user interface 800 for interacting with one or more event profiles associated with a sporting event. One embodiment is a smart-phone social networking application that allows attendee users to access functions that include ticketing, social media, concessions, merchandise, promotions, user generated content, and the like.

One exemplary embodiment of the user interface 800 is first interface 800A, which is shown in FIG. 8A. Turning to FIG. 8A, the first interface 800A comprises a menu area 810 comprising a set of icons that provide access to functions that include ticketing, social media, concessions, merchandise, promotions, user generated content, and the like. Icons can include alert symbols proximate to the icons, which can indicate active messages, offers, orders, deliveries, or the like. For example, the number one by the promotions icon may indicate that there is one pending un-viewed promotion available to the attending user via the interface 800.

A second interface 800B is shown in FIG. 8B. The second interface 800B can comprise a promotional field 815 that presents promotional events, activities, offers or the like. For example, as depicted in FIG. 8B, a promotional event can include a tailgate bonfire rally sponsored by Mercedes-Benz. The promotional field 815 can include information such as a time, place, description, and features of a promotional event as shown in FIG. 8B, and can also include a button that allows the attending user to RSVP, sign up for the event, or provide an attendance indication for the event (e.g., the “Join Now!” button).

A third interface 800C is shown in FIG. 8C. The third interface 800C can comprise a concessions field 820 that presents concession items such as food and drinks that a user can purchase at an event. As described herein in some embodiments, concessions can be delivered to a seat or other defined location at an event or scheduled for pickup at a defined location. The concessions field 820 can include buttons that allow the attending user to buy a given concession item (e.g., the “Buy Now” button).

A fourth interface 800D is shown in FIG. 8D. The fourth interface 800D can comprise a merchandise field 825 that presents merchandise items that a user can purchase in association with an event. As described herein in some embodiments, merchandise can be delivered to a seat or other defined location at an event or can be scheduled for delivery or pickup at a defined location. The merchandise field 825 can include buttons that allow the attending user to buy a given merchandise item (e.g., the “Buy Now” button).

A fifth interface 800E is shown in FIG. 8E. The fifth interface 800E can comprise a social networking field 830 that allows a user to generate, interact with, share, or consume content from social networks in relation to an event. For example, in some embodiments, the fifth interface 800E can allow attendee users to share content such as highlight videos, concert clips, images, text, or the like. In various embodiments, shared content can be displayed at the event on one or more screens, or the like. In other embodiments, such shared content can be displayed on a social media website associated with the event such as a Facebook, Twitter, or Instagram account.

In further embodiments, attendee users can participate in a game or other activity that occurs at an event. Such an event can be in real-time or can be time-delayed. For example, an interface 800 can allow attendee users to vote in a poll that is displayed at the event, to provide input that affects a real-time video game, or the like.

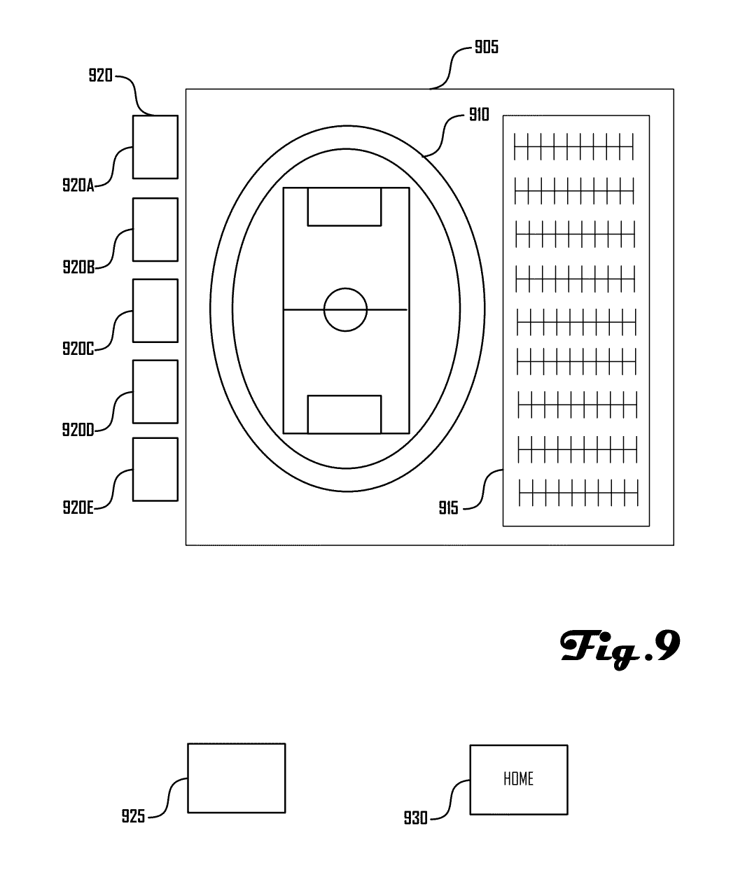

FIG. 9 is an exemplary top-level drawing illustrating an embodiment of a stadium event location 905 for use with the social networking system 100 of FIG. 1. The event location 905 is shown including a stadium 910 and parking area 915. Additionally, there can be a plurality of locations 920 proximate to the event location 905, and in various embodiments, the locations 920 can comprise bars, restaurants, hotels, clubs, or the like. Additionally there can be locations 925, 930 that are disparate from the event location 905, which can include a home of a user 930 as discussed in more detail herein. Although shown and described with reference to a stadium 910 and parking area 915 for purposes of illustration only, the event location 905 can comprise any suitable additional locations, features, or the like.

In various embodiments, a social networking system 100 can be configured to provide social networking, advertising, and purchasing functionalities in relation to a sporting event such as a soccer match (i.e., football outside of the United States). In some embodiments, the user interface 700, 800 (shown in FIGS. 7A-D, 8A-E) and content provided by the user interface 700, 800 can be customized based on user profile data, user location, time and the like.

For example, assume a soccer match is being played at the event location 905. Users can view the soccer match from various proximate locations including live at the stadium 910, at a location 920 near the stadium, at a distal location 925 that is not a home, or at a distal location that is a home 930. Users can remain at a single location or can move within any of these proximal and/or distal locations or among them at various times including before the game, during the game, and after the game.

For example, system server 140 can determine or receive an indication that a given user is planning on attending a game live at the stadium 910. The server 140 can have or receive data indicating that the user has tickets or that the user intends to attend the game. In some embodiments, the attendee device 110 can prompt users to indicate whether they are planning to attend a given event.

If it is known that the user is planning to attend the game live at the stadium 910, the attendee device 110 can be configured for the user while at home 930; for the journey to the stadium 910; for the live event at the stadium 910; for the journey from the stadium 910 back home 930, and while at home 930 after the game. For example, before the game, location data can indicate that the user is still at home, and the attendee device 110 of the user may be configured to alert the user when the game is starting; how long it will take to journey to the stadium 910 via various modes of transportation; and provide an alert when the user should leave home 930 via a defined mode of transportation. If the user is traveling in a car, the user can reserve a parking spot in the parking area 915 and receive directions to the parking spot. The user can pre-order merchandise or concessions to be delivered to the user's seat at a defined time while at home or traveling to the stadium. In some embodiments, the user can receive offers to upgrade seating from the seating that the user already has (e.g., to box seats or the like). If the user upgrades, any location based delivery can be automatically changed to the new seating location. For example, a change in an attending user's seating location can trigger changes in order data or other location-related data.

After arriving at the event location 905, users can be directed to their seats or can receive advertisements or notifications of events or promotions in or proximate to the event location. For example, users can be notified of a pre-game tailgate party (see, e.g., FIG. 8B), free merchandise give-away, mascot or team meet-and-greet, promotions, food, drinks, merchandise, or services, or the like. The user can pre-order merchandise or concessions to be delivered to the user's seat at a defined time or for pickup at a location within the stadium 910. In various embodiments, the users can be able to alert stadium staff to issues such as unclean facilities, security issues, unruly attendees, or the like, and such an alert can be based on the location of the attendee device 110 associated with the user.

The user can receive alerts or advertisements based on defined events that occur in the game or based on time remaining in the game. For example, promotions can be awarded if certain events occur in a game (e.g., the soccer team scores three goals, the football team scores over 40 points, or the like). When such a promotional event occurs, the user can receive a notification and coupon for the promotion. Additionally, at a defined time before the game ends, users can receive advertisements or alerts related to post-game activities, which can include events within the stadium 910 (e.g., free merchandise give-away, mascot or team meet-and-greet, or the like). The users can receive promotions related to locations 920 proximate to the stadium 910 (e.g., restaurants, bars, event locations), or locations 925 that are determined to be close to the user's home 930 or on the way home from the stadium 910.

For example, system server 140 can determine or receive an indication that a given user is not planning on attending a game live at the stadium 910, but that the user will or is proximate to the stadium 910 (e.g., at one of locations 920A-E). The user can receive promotions or advertisements about tickets to see the game live at the stadium 910 based on location, or can receive promotions or advertisements related to other locations proximate to their present location. However, if it is determined that the user is not at the stadium 910 and therefore without access to the amenities associated with the stadium 910, this user may have more limited functionalities compared to a user that is at the stadium 910.

Similarly, for a user that is watching the game from home 930 at a location that is disparate from the stadium 910, the user may receive different alerts and advertisements compared to a user that is proximate to or at the stadium 910. For example, the user at home 930 can receive advertisement for a location 925 that is close to the user's house.

Where a determination is made, or an indication is provided, that a user is watching the game via television, advertisements or promotions can be associated with or correspond to commercials that occur during the telecast of the game that the user is watching or events that occur during the game.

Similarly, where users are watching various other telecasts or television shows, an attendee device 110 can be configured based on commercials or events that occur during such a telecast. For example, if a commercial for a given product or brand appears, the user can receive an advertisement or alert related to this product or brand. In another example, if a celebrity appears on a telecast, the user can receive an advertisement or alert related to a product or service that is being sold by or endorsed by the celebrity, regardless of whether the product or service is mentioned or referenced in the telecast.

In various embodiments, the attendee device 110 may be unable to complete financial transactions or such transactions may be prohibited or disabled when the attendee device 110 operates on certain networks 150. Accordingly, in various embodiments a user can pre-order credits for various goods or services and request delivery of these goods or services while attending an event. For example, the user can pre-buy a package for drinks and food at a sporting event and the user can request delivery to the user's seat while at the game or schedule pickup at a desired location.

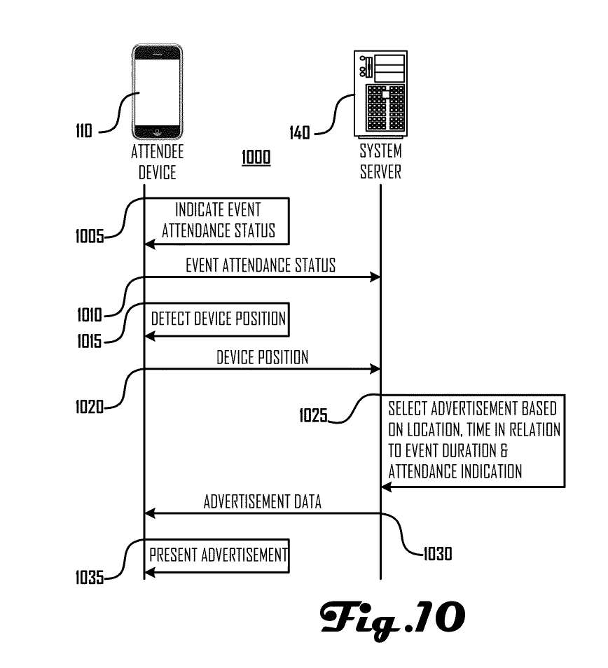

FIG. 10 is another exemplary data flow diagram illustrating an embodiment of a data flow path 1000 between the attendee device 110 and system server 140 for selecting and presenting advertisements based on location of the attendee device 110, time in relation to an event-duration, and an event attendance indication.

The data flow 1000 begins where an event attendance status is indicated, at 1005, and the event attendance status is sent to the system server 140, at 1010. For example, referring to the soccer game example discussed above, the user can actively indicate planned attendance at the soccer game stadium 910 or such an indication can be provided passively when a user buys tickets for the game, or the like.

At 1015, the attendee device 110 detects a device position and the device position is sent to the system server 140, at 1020. Position detection can occur via one or more conventional methods including sensing global positioning (“GPS”) data, compass data, cell tower proximity data, wireless network proximity data, or the like.

The system server 140 selects an advertisement based on the device position, time in relation to an event-duration, and the attendance indication, at 1025. The advertisement data is sent to the attendee device, at 1030, where it is presented at 1035. For example, as discussed above, a soccer game can have a defined event-duration which can correspond to the time frame in which the game is played. There is also pre-game and post-game time outside of this event-duration. As discussed above, advertisements, alerts, promotions or the like can be selected based on time in relation to the event-duration (i.e., before, during or after the event-duration), based on the user's location, and based on the indication of whether the user plans to or has tickets to attend the game.

In various embodiments, advertisements can be selected periodically before, after or during an event-duration. The user's location can change before, after or during an event-duration, and the event attendance status can change before, after or during an event-duration. Such changes can influence the advertisements, alerts, promotions or the like that can be selected for the user.

Determined distance from an event location can also be used to determine the advertisements that are served to the user. For example, distances such as at the event location, proximate to the event location and the user being disparate from the event location can be some distance measures that are used to provide different advertisements. In various embodiments, being at an event location can mean being within the bounds of a ticketed or access-controlled event, where persons without access permission are unable to attend the event.

Determinations that a user is at an access-controlled event location or plans to be at an access-controlled event location can be desirable because interface functionalities related to goods or services that are only available within the event location can be selectively activated because the user has or will have access to these goods or services by way of being present at the event location.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for providing a location-based social network, comprising:
configuring an event profile via an event administrator device, the event profile being associated with an event location and including at least one location venue;
configuring a first event venue profile via a first venue device, the first event venue profile being associated with a first location venue and being configurable via the event administrator device; and
presenting an event interface at an attendee device, the event interface being defined by the event profile and the first event venue profile.

2. The method of claim 1, further comprising configuring a second event venue profile via a second venue device, the second event venue profile being associated with a second location venue and configurable by the event administrator device; and
wherein the event interface is further defined by the second event venue profile.

3. The method of claim 2, wherein said configuring the first and second event venue profiles includes defining first and second event profile configuration parameters for the first and second event venue profiles via the event administrator device.

4. The method of claim 3, wherein the first and second event profile configuration parameters are different.

5. The method of claim 2,
wherein the first event venue profile is associated with a first event venue location that is a first portion of the event location;
wherein the second event venue profile is associated with a second event venue location that is a second portion of the event location; and
wherein the first and second portions of the event location are different.

6. The method of claim 1, wherein said configuring the first event venue profile includes defining first event profile configuration parameters for the first event venue profile via the event administrator device.

7. The method of claim 1, further comprising associating a first event venue profile with a first event venue location that is a portion of the event location.

8. The method of claim 7, wherein the attendee device is operable to order goods or services via the event interface for delivery at an event site location that is a portion of the event location and that is different than the first event venue location.

9. The method of claim 1, further comprising associating a vendor with the first event venue profile, and wherein the attendee device is operable to order goods or services from the vendor via the event interface.

10. The method of claim 1, further comprising associating a vendor with the event profile, and wherein the attendee device is operable to order goods or services from the vendor via the event interface.
